(19) United States
(12) Patent Application Publication
(10) Pub. No.: US 2026/0120036 A1
(43) Pub. Date: Apr. 30, 2026

(54) SYSTEM AND METHOD FOR AUTOMATED GOVERNANCE, COMPLIANCE, SAFETY, AND SUSTAINABILITY EVALUATION OF ARTIFICIAL INTELLIGENCE MODELS

(71) Applicant: Keerthana Kalyanasundaram, Southlake, TX (US)

(72) Inventor: Keerthana Kalyanasundaram, Southlake, TX (US)

(21) Appl. No.: 19/432,530

(22) Filed: Dec. 24, 2025

(51) Int. Cl. G06Q 10/0637; G06Q 10/0631

(52) U.S. Cl. CPC G06Q 10/06375; G06Q 10/06312

(57) ABSTRACT

A system comprises a processor, and a memory operatively coupled with the processor, wherein the memory comprises processor-executable instructions which, when executed by the processor, cause the processor to activate an ingestion layer, a normalization module, a regulatory mapping module, a scoring module, a sustainability scoring module, a policy gateway module, a dynamic monitoring module, an automated action module, a hospital-vendor compatibility module, and a regulatory evidence module. The system integrates with at least one of clinical electronic health records (EHRs), picture archiving and communication system (PACS), and health level seven (HL7) endpoint or fast healthcare interoperability resources (FHIR) endpoint to block real-time model invocation when ARCSI falls below a context-specific threshold. The system operates continuously post-deployment without retraining the AI model.

### FIELD OF INVENTION

The present disclosure relates generally to governance, compliance, and lifecycle management of artificial intelligence systems, and more particularly to automated system and method for evaluating regulatory compliance, safety, security, bias, and sustainability of artificial intelligence models deployed in healthcare and other regulated environments.

### BACKGROUND

Artificial intelligence (AI) models are increasingly deployed in clinical decision support, diagnostic imaging, patient monitoring, operational optimization, and administrative workflows. In regulated domains such as healthcare, finance, and critical infrastructure, such AI systems must comply with a growing set of regulatory, ethical, and operational requirements, including privacy protection, safety assurance, bias mitigation, cybersecurity, auditability, and environmental sustainability. Ensuring that AI systems remain compliant and safe throughout their lifecycle has therefore become a critical technical and regulatory challenge.

Despite rapid adoption, organizations deploying AI systems face several significant problems. Regulatory fragmentation exists across jurisdictions and frameworks. Healthcare AI systems may simultaneously fall under the Health Insurance Portability and Accountability Act (HIPAA), Food and Drug Administration Software as a Medical Device (FDA SaMD) guidance, National Institute of Standards and Technology Artificial Intelligence Risk Management Framework (NIST AI RMF), ISO/IEC 42001, ISO/IEC 27001/27701, the General Data Protection Regulation (GDPR), and the European Union Artificial Intelligence Act (EU AI Act). Each framework defines different controls, documentation requirements, and risk thresholds, making manual compliance management complex and error-prone.

AI systems are dynamic by nature. Model performance, bias characteristics, data distributions, security posture, and energy consumption can change over time due to data drift, retraining, infrastructure updates, or regulatory changes. Static, one-time assessments performed prior to deployment are therefore insufficient to ensure ongoing safety and compliance.

Further, AI vendors provide heterogeneous and unstructured evidence, such as PDFs, spreadsheets, logs, and certificates, which are difficult to compare, validate, or audit across vendors and deployment environments. This lack of standardization prevents consistent evaluation of AI readiness and risk.

Existing oversight processes are largely manual and reactive, relying on human review of documentation, periodic audits, and post-incident investigations. Such approaches do not provide real-time protection against emerging risks, particularly in high-risk clinical environments such as intensive care units. Furthermore, emerging regulatory regimes increasingly require traceability, auditability, and post-market monitoring, including the ability to reconstruct historical compliance states and demonstrate risk-management actions taken over time. Conventional record-keeping systems are not designed to support such granular, time-sequenced evidence reconstruction.

To address these challenges, various existing technologies and approaches have been employed in the art. Manual compliance checklists and policy documentation, maintained by legal, compliance, or quality assurance teams. Point-in-time validation reports and vendor certifications provided during procurement or pre-deployment review. Model monitoring tools that track limited metrics such as accuracy, latency, or uptime. Data governance platforms focused primarily on access control and data lineage. Security information and event management (SIEM) systems for cybersecurity monitoring. Standalone audit repositories used to store regulatory documentation. Some emerging platforms attempt to aggregate compliance information or provide dashboards for AI risk assessment; however, these systems typically operate as static reporting tools rather than autonomous governance systems.

Notwithstanding their use, the above-described technologies suffer from several limitations. Existing systems do not provide unified, machine-readable normalization of evidence across heterogeneous AI vendors, preventing objective and automated comparison. Compliance tools typically treat regulatory frameworks independently, lacking automated mapping between technical evidence and specific regulatory obligations across multiple jurisdictions. Current solutions lack dynamic, multi-dimensional risk scoring that integrates algorithmic robustness, regulatory maturity, clinical safety, security, and sustainability into a single actionable metric. Monitoring systems operate in isolation and do not trigger automated governance actions, such as throttling, blocking, rerouting, or revalidation of AI models when risk thresholds are exceeded. Sustainability considerations such as energy consumption, carbon intensity, and infrastructure efficiency are rarely integrated into AI governance platforms, despite increasing regulatory and institutional emphasis on environmental impact. Finally, existing audit and documentation systems are not designed to maintain tamper-evident, time-sequenced records capable of reconstructing historical compliance states in response to regulatory inquiries or post-incident investigations.

Therefore, there is a need for a technically integrated, automated, and continuous AI governance system that overcomes the foregoing limitations by ingesting heterogeneous evidence, normalizing such evidence into a unified schema, mapping the evidence to multiple regulatory frameworks, dynamically scoring AI systems across multiple risk dimensions, continuously monitoring operational and regulatory changes, enforcing consent and policy controls, automatically executing risk-mitigation actions, and maintaining an audit-ready, tamper-evident evidence repository.

### SUMMARY OF THE INVENTION

The following presents a simplified summary of one or more embodiments of the present disclosure to provide a basic understanding of such embodiments. This summary is not an extensive overview of all contemplated embodiments and is intended to neither identify key nor critical elements of all embodiments, nor delineate the scope of any or all embodiments.

The present disclosure, in one or more embodiments, relates to a system for automated governance, compliance evaluation, safety assessment, and sustainability scoring of artificial intelligence (AI) models. The system automatically generates remediation pathways with prioritized actions, due-date schedules, and required validation artifacts for vendor submission.

In operation, the disclosed system performs machine-executed ingestion of heterogeneous, machine-readable evidence associated with an artificial intelligence (AI) model, automatically normalizes and classifies such evidence into a unified evidence schema, computes quantitative risk, compliance, safety, and sustainability scores using one or more processors, and programmatically triggers system-initiated control actions. The control actions include modifying downstream AI model execution, data flow, or infrastructure routing within an operational environment without human intervention, thereby enforcing governance, compliance, safety, and sustainability constraints through computer-implemented processes.

The system comprises a processor, and a memory operatively coupled with the processor, wherein the memory comprises processor-executable instructions which, when executed by the processor, cause the processor to activate an ingestion layer, a normalization module, a regulatory mapping module, a scoring module, a sustainability scoring module, a policy gateway module, a dynamic monitoring module, an automated action module, a hospital-vendor compatibility module, and a regulatory evidence module. The system integrates with at least one of clinical electronic health records (EHRs), picture archiving and communication system (PACS), and health level seven (HL7) endpoint or fast healthcare interoperability resources (FHIR) endpoint to block real-time model invocation when ARCSI falls below a context-specific threshold. The system operates continuously post-deployment without retraining the AI model.

In one embodiment, the ingestion layer is configured to receive heterogeneous evidence associated with an AI model. The heterogeneous evidence comprises at least one of technical documentation, operational logs, model outputs, clinical validation data, regulatory certifications, cybersecurity artifacts, and sustainability telemetry.

In one embodiment, the normalization module is configured to convert the heterogeneous evidence into a unified structured representation stored in a unified evidence schema (UES). The UES comprises a plurality of fields for dataset lineage, performance metrics, clinical safety indicators, regulatory mappings, security posture, operational metadata, sustainability parameters, and provenance hashes.

In one embodiment, the regulatory mapping module is configured to automatically map the plurality of fields to regulatory controls defined by one or more regulatory frameworks, and to generate a compliance matrix identifying at least one of coverage states, evidence pointers, and remediation gaps. The regulatory frameworks comprise at least one of health insurance portability and accountability act (HIPAA), food and drug administration (FDA) software as a medical device (SaMD) guidance, office of the national coordinator for health information technology health data, technology, and interoperability rule (ONC HTI-1), national institute of standards and technology artificial intelligence risk management framework (NIST AI RMF), ISO/IEC 42001 artificial intelligence management system standard, ISO/IEC 27001 and ISO/IEC 27701 information security and privacy standards, general data protection regulation (GDPR), and European union artificial intelligence act (EU AI Act).

In one embodiment, the scoring module is configured to compute one or more components of an adaptive risk, compliance, and sustainability index (ARCSI), and aggregate the components into an ARCSI score for the AI model. The scoring module comprises a plurality of scoring modules, including at least one of an algorithmic robustness module, a regulatory maturity module, a clinical safety and bias module, a security and privacy module, and an infrastructure and sustainability module.

In one embodiment, the sustainability scoring module is configured to compute environmental impact using one or more parameters, and generate a sustainability impact score (SIS). The sustainability scoring module is configured to compute the environmental impact and a region-specific carbon-optimized routing suggestion for inference workloads across multiple cloud or on-premise deployments using the one or more parameters comprise at least one of energy-per-inference, power-usage-effectiveness (PUE), cloud-region carbon intensity, water-per-kWh, and hardware-type emissions.

In one embodiment, the policy gateway module is configured to enforce data-minimization, jurisdiction rules, consent requirements, and attribute restrictions by applying at least one of masking, truncation, hashing, attribute removal, obfuscation, payload blocking, and routing transformations prior to permitting model invocation in a clinical workflow. The policy gateway module incorporates a machine learning-based classifier trained to label incoming payloads as at least one of compliant, non-compliant, and uncertain, and triggers automatic blocking or manual review for uncertain payloads. The policy gateway module enforces cross-border data residency rules by rewriting payloads to remove jurisdiction-restricted attributes.

In one embodiment, the dynamic monitoring module is configured to perform continuous or periodic monitoring of deployed AI models for detecting at least one of drift, bias spikes, hallucination patterns, latency anomalies, version changes, sustainability anomalies, and regulatory updates, and triggering real-time recalculation of the ARCSI score. The dynamic monitoring module is configured to adjust the ARCSI component weights dynamically such that clinical safety and algorithmic robustness are increased in response to the drift, and security and regulatory weights are elevated in response to vendor breach events. The drift is detected using at least one of population stability index (PSI), Kullback-Leibler (KL) divergence, moving-window performance decay, hallucination-rate spikes, and subgroup-specific accuracy degradation.

In one embodiment, the automated action module is configured to perform at least one of context-aware remediation actions comprises model throttling, clinical-workflow blocking, region-based routing changes, sustainability-optimized allocation, and mandatory vendor revalidation, responsive to the recalculated ARCSI score falling below a configurable threshold. The automated action module dynamically re-allocates inference traffic to minimize carbon per inference while maintaining latency and safety thresholds.

In one embodiment, the hospital-vendor compatibility module is configured to compute a compatibility score using features representing vendor compliance posture and hospital infrastructure constraints, and to classify the AI model into a deployment-eligibility category. The hospital-vendor compatibility module is adapted to predict deployment success probability using features comprises EHR type, network latency, cloud strategy, data residency constraints, sustainability goals, and staff workflows. The hospital-vendor compatibility module is adapted to output a market-eligibility category selected from high-likelihood, moderate-likelihood, and low-likelihood deployment suitability.

In one embodiment, the regulatory evidence module is configured to store immutable audit records for each ingestion event, mapping operation, scoring computation, monitoring event, or gateway decision, each audit record comprises timestamp, actor identifier, event type, before/after state hashes, and a previous-record hash forming a tamper-evident chain. The regulatory mapping module assigns the control-coverage states selected from complete, partial, none, and not-applicable, and applies evidence-strength confidence scores. The regulatory evidence module provides time-travel reconstruction of model behavior, policy decisions, and scoring calculations for a selected historical window. The regulatory evidence module automatically assembles one or more regulator-ready bundles comprise at least one of software as a medical device (SaMD) documentation, health insurance portability and accountability act (HIPAA) mappings, general data protection regulation (GDPR) data-minimization evidence, and European Union (EU) Artificial Intelligence (AI) Act risk-management artifacts.

An embodiment of the first aspect wherein a computer-implemented method for evaluating and monitoring artificial intelligence (AI) models in healthcare or regulated enterprise workflows. At first step, the ingestion layer is executed on the processor for receiving the heterogeneous evidence associated with the AI model.

Next, the normalization module normalizes the heterogeneous evidence into unified structured evidence stored in the UES. Next, the regulatory mapping module maps the unified structured evidence to the regulatory frameworks and generating a compliance-gap matrix. Next, the scoring module computes the components of ARCSI by evaluating algorithmic robustness, regulatory maturity, clinical safety, bias, security, privacy, interoperability, and sustainability, and aggregate the components into the ARCSI score for the AI model.

Next, the sustainability scoring module generates a sustainability impact score (SIS) using one or more parameters of environmental impact. Next, the policy gateway module enforces data-minimization, jurisdiction rules, consent requirements, and attribute restrictions by applying at least one of masking, truncation, hashing, attribute removal, obfuscation, payload blocking, and routing transformations prior to permitting model invocation in the clinical workflow.

Next, the dynamic monitoring module monitors model behavior for drift, bias, hallucination, anomalies, and regulatory changes, and dynamically recalculates ARCSI weights responsive to detected events.

Next, the automated action module performs at least one of context-aware remediation actions comprising model throttling, clinical-workflow blocking, region-based routing changes, sustainability-optimized allocation, and mandatory vendor revalidation, responsive to the recalculated ARCSI score falling below a configurable threshold. At least one corrective action is performed automatically without human intervention.

Later, the regulatory evidence module generates the regulator-ready bundles comprise at least one of software as SaMD documentation, HIPAA mappings, GDPR data-minimization evidence, and EU AI Act risk-management artifacts.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate an embodiment of the invention, and, together with the description, explain the principles of the invention.

FIG. 1 illustrates a block diagram of an exemplary block diagram representation of a network architecture in which a system is implemented for automated governance, compliance evaluation, safety assessment, and sustainability scoring of artificial intelligence (AI) models, in accordance with embodiments of the invention.

FIG. 2 illustrates a flowchart of a computer-implemented method for evaluating and monitoring artificial intelligence (AI) models in healthcare or regulated enterprise workflows, in accordance with embodiments of the invention.

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

The embodiments described herein are implemented as computer-executed processes performed by one or more processors operating on machine-readable evidence and telemetry. The disclosed system 100 does not merely generate reports or human-interpretable assessments, but instead produces computed outputs that directly control system behavior, including artificial intelligence (AI) model invocation permissions, data transformations, routing decisions, and automated remediation actions within live operational workflows. These operations are executed by the system 100 in response to dynamically computed scores and thresholds derived from normalized evidence, which may be derived using one or more techniques and updated over time.

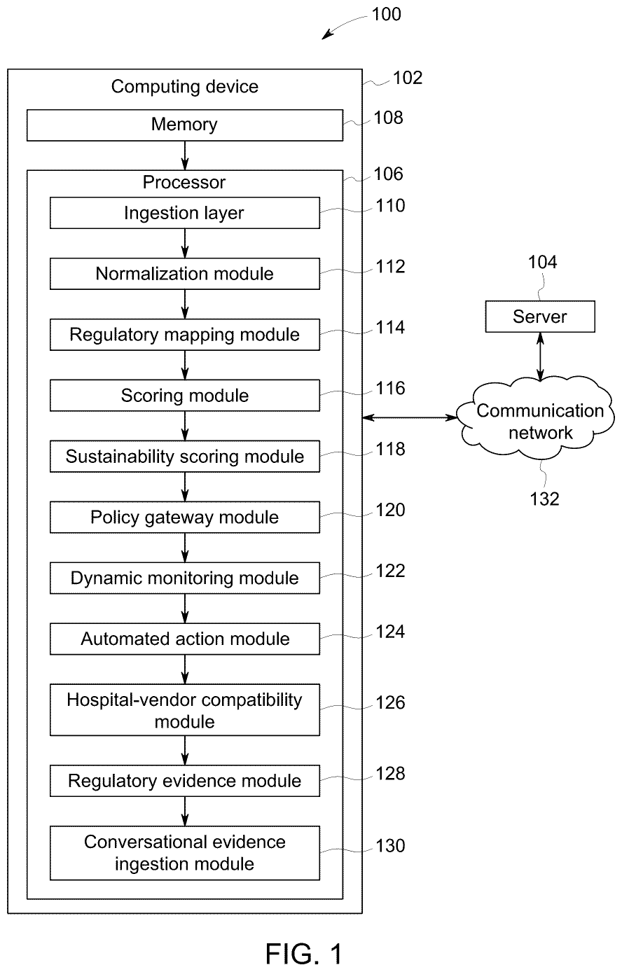

FIG. 1 refers to a block diagram of an exemplary block diagram representation of a network architecture of a system 100 may be implemented for automated governance, compliance evaluation, safety assessment, and sustainability scoring of artificial intelligence (AI) models, in accordance with embodiments of the present disclosure. The system 100 automatically generates remediation pathways with prioritized actions, due-date schedules, and required validation artifacts for vendor submission.

In one embodiment herein, the system 100 is configured to evaluate artificial intelligence (AI) models associated with vendor-side system instances, deploying-organization system instances, or combinations thereof, including hospital or enterprise operational environments in which the AI models are developed, validated, deployed, monitored, or governed. In exemplary embodiments, the AI models deployed in healthcare and other regulated environments include, but are not limited to, clinical decision support AI systems, diagnostic imaging AI models include radiology, CT, MRI, and X-ray analysis models, AI models used for patient monitoring, predictive clinical and operational risk scoring models, and natural language processing (NLP) models for clinical documentation, summarization, or coding support, thereof. The system 100 is additionally applicable to AI models deployed in other regulated industries include, but not limited to, finance, insurance, critical infrastructure, and public safety.

The system 100 comprises a computing device 102 having a processor 106 and a memory 108. The memory 108 comprises processor-executable instructions which, when executed by the processor 106, cause the processor 106 to activate an ingestion layer 110, a normalization module 112, a regulatory mapping module 114, a scoring module 116, a sustainability scoring module 118, a policy gateway module 120, a dynamic monitoring module 122, an automated action module 124, a hospital-vendor compatibility module 126, and a regulatory evidence module 128. The system 100 integrates with at least one of clinical electronic health records (EHRs), picture archiving and communication system (PACS), and health level seven (HL7) endpoint or fast healthcare interoperability resources (FHIR) endpoint to block real-time model invocation when ARCSI falls below a context-specific threshold. The system 100 operates continuously post-deployment without retraining the AI models.

In another embodiment, the system 100 with the network architecture may include, one or more databases, a user device, and a server 104. The server 104 may be, but are not limited to, a cloud server, a centralized server, a rack server, a network server, a computer-based server, on premise server, a dedicated server, a remote server, and the like.

In some embodiment, the server 104 may include the ingestion layer 110, the normalization module 112, the regulatory mapping module 114, the scoring module 116, a sustainability scoring module 118, the policy gateway module 120, the dynamic monitoring module 122, the automated action module 124, the hospital-vendor compatibility module 126, and the regulatory evidence module 128. The system 100, and the server 104 may be communicatively coupled to the user device via a communication network 132. The communication network 132 may be a wired communication network and/or a wireless communication network.

In some embodiments, the user device may be associated with, but not limited to, a user, an individual, an administrator, a vendor, a technician, a worker, a specialist, an instructor, a supervisor, a team, an entity, an organization, a company, a facility, a bot, any other user, and combination thereof. The entities, the organization, and the facility may include, but are not limited to, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility and the like. The user device may be used to provide input and/or receive output to/from the system 100. The user device may present to the user one or more user interfaces for the user to interact with the system 100 for responsible AI compliance and governance management in AI models needs. The user device may be at least one of, an electrical, an electronic, an electromechanical, and a computing device. The user device may include, but is not limited to, a mobile device, a smartphone, a personal digital assistant (PDA), a tablet computer, a phablet computer, a wearable computing device, a virtual reality/augmented reality (VR/AR) device, a laptop, a desktop, a server, and the like.

Further, the system 100 may be implemented by way of a single device or a combination of multiple devices that may be operatively connected or networked together. The system 100 may be implemented in hardware or a suitable combination of hardware and software. The system 100 may be a hardware device including the processor 106 executing machine-readable program instructions for intelligent and continuous responsible AI compliance and governance management in AI models. Execution of the machine-readable program instructions by the processor 106 may enable the proposed system 100 to perform responsible AI compliance and governance management. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

In one embodiment, the processor 106 may include, for example, microprocessors, microcomputers, microcontrollers, digital signal processors, central processing units, state machines, logic circuits, and/or any devices that manipulate data or signals based on operational instructions. Among other capabilities, the processor 106 may fetch and execute computer-readable instructions in the memory 108 operationally coupled with the system 100 for performing tasks such as data processing, input/output processing, and/or any other functions. Any reference to a task in the present disclosure may refer to an operation being or that may be performed on data.

In another embodiment, the memory 108 referred herein include at least one type of storage medium, from among a flash memory type storage medium, a hard disk type storage medium, a multi-media card micro type storage medium, a card type memory (for example, an SD or an XD memory), random-access memory (RAM), static RAM (SRAM), read-only memory (ROM), electrically erasable programmable ROM (EEPROM), programmable ROM (PROM), a magnetic memory, a magnetic disk, or an optical disk.

In some embodiments, the memory 108 stores pre-trained AI models that are periodically updated through cloud-based learning. Model parameters, neural network weights, and other elements essential for accurate decision-making.

In one embodiment, the processor 106 acts as the central processing unit (CPU) of the system 100, responsible for coordinating different tasks and carrying out complex operations, data processing, and decision-making by fetching instructions from the memory 108, thereby decoding the instructions and executing the necessary actions.

The term “processor” used herein may refer to a hardware processor comprising a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof. As such, in some embodiments, the processor may comprise one or more processing cores configured to perform independently.

In one embodiment herein, the memory 108 serves as the storage component of the system 100, holding the executable instructions, as well as any data or information required by the processor 106 to perform its tasks. The data includes user inputs, system configurations, and any other relevant data needed for the system's operations. Through the communication between the processor 106 and the memory 108, the system 100 is able to process the user inputs, access stored information, perform computations, and make decisions accordingly.

Though few components and subsystems are disclosed in FIG. 1, there may be additional components and subsystems which is not shown, such as, but not limited to, ports, network devices, databases, network attached storage devices, assets, machinery, instruments, facility equipment, emergency management devices, image capturing devices, cooling devices, heating devices, compressors, any other devices, and combination thereof. The person skilled in the art should not be limiting the components/subsystems shown in FIG. 1.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, Bluetooth adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 100 as is unique to the present disclosure or necessary for an understanding of the present disclosure is depicted and described. The remainder of the construction and operation of the system 100 may conform to any of the various current implementations and practices that were known in the art.

In one embodiment herein, the system 100 is configured to operate as a digital platform. In one embodiment herein, the system 100 may be implemented in various forms include, but not limited to, a software application installed on the computing device 102, for example, a personal computer or other computing devices, a mobile application designed for smartphones or tablets, and a webpage application (web app) that operates within standard internet browsers. These implementations enable broad accessibility and ensure compatibility with multiple user environments.

In one embodiment herein, the system 100 is configured to operate as a digital platform. In one embodiment herein, the system 100 may be implemented in various forms include, but not limited to, a software application installed on the computing device 102, for example, a personal computer or other computing devices, a mobile application designed for smartphones or tablets, and a webpage application (web app) that operates within standard internet browsers. These implementations enable broad accessibility and ensure compatibility with multiple user environments.

In another embodiment, the computing device 102 represents any electronic device that a user can utilize to interact with the system 100. The computing device 102 can be, but not limited to, a smartphone, a laptop, a tablet, a personal computer, or any other suitable electronic device. The computing device 102 serves as the user's gateway for accessing and interacting with the system 100. The computing device 102 is configured to enable the user to engage with the system's functionalities and capabilities through a user interface.

In some embodiments, the communication network 132 can be, but not limited to, Local Area Network (LAN), Cellular Network, Wide Area Network (WAN), Intranet, Virtual Private Network (VPN), and wireless networks that use radio frequency (RF) or infrared (IR) technology to transmit data without the need for physical cables, thereby providing mobility and flexibility. The versatility of the communication network 132 ensures that the computing device 102 can seamlessly connect to third-party travel service interfaces and the server 104, thereby enabling the user to access the system's 100 functionalities and resources from a variety of locations and devices. This wireless connectivity enhances the overall accessibility and convenience of the system 100 for the user. In one embodiment, the third-party travel service interfaces are application programming interface (API).

In one embodiment, the ingestion layer 110 is configured to receive heterogeneous evidence associated with an AI model. The heterogeneous evidence comprises at least one of technical documentation, operational logs, model outputs, clinical validation data, regulatory certifications, cybersecurity artifacts, and sustainability telemetry.

In one embodiment, the ingestion layer 110 receives heterogeneous evidence originating from vendor-side AI development, validation, certification, and disclosure systems, and from deploying-organization operational, governance, monitoring, and compliance systems, such that evidence from both sides of the AI lifecycle is processed in a unified manner.

In one embodiment, the heterogeneous evidence further comprises hospital-provided governance inputs including clinical use-case classification, deployment phase designation, internal risk thresholds, approval policies, and institutional compliance requirements, which are normalized into the unified evidence schema alongside vendor-associated artifacts.

In another embodiment, the heterogeneous evidence comprises static artifacts, dynamic operational signals, and external or market-intelligence inputs, each of which may be ingested and evaluated prior to deployment, during pilot or validation phases, and continuously during post-deployment operation. These input categories apply to both vendor-side evaluations and deploying-organization-side evaluations, thereby enabling continuous lifecycle governance of the AI model.

In one embodiment, the normalization module 112 is configured to convert the heterogeneous evidence into a unified structured representation stored in a unified evidence schema (UES). The UES comprises a plurality of fields for dataset lineage, performance metrics, clinical safety indicators, regulatory mappings, security posture, operational metadata, sustainability parameters, and provenance hashes.

In one embodiment, the regulatory mapping module 114 is configured to automatically map the plurality of fields to regulatory controls defined by one or more regulatory frameworks, and to generate a compliance matrix identifying at least one of coverage states, evidence pointers, and remediation gaps. The regulatory frameworks comprise at least one of health insurance portability and accountability act (HIPAA), food and drug administration (FDA) software as a medical device (SaMD) guidance, office of the national coordinator for health information technology health data, technology, and interoperability rule (ONC HTI-1), national institute of standards and technology artificial intelligence risk management framework (NIST AI RMF), ISO/IEC 42001 artificial intelligence management system 100 standard, ISO/IEC 27001 and ISO/IEC 27701 information security and privacy standards, general data protection regulation (GDPR), and European union artificial intelligence act (EU AI Act).

In one embodiment, the scoring module 116 is configured to compute one or more components of an adaptive risk, compliance, and sustainability index (ARCSI), and aggregate the components into an ARCSI score for the AI model. The scoring module 116 comprises a plurality of scoring modules, including at least one of an algorithmic robustness module, a regulatory maturity module, a clinical safety and bias module, a security and privacy module, and an infrastructure and sustainability module.

In one embodiment herein, the adaptive risk, compliance, and sustainability index (ARCSI) is computed using a weighted aggregation of component scores including algorithmic robustness, clinical safety, bias, security posture, regulatory maturity, and sustainability parameters. Each component score is computed as a normalized numerical value between 0 and 1. The processor 106 dynamically adjusts weighting coefficients in response to detected events. For example, upon detecting data drift, the processor 106 increases the weight assigned to algorithmic robustness and clinical safety components, while upon detecting a cybersecurity breach or vendor policy violation, the processor 106 increases the weight assigned to security and regulatory maturity components. Weight adjustment may be performed using rules-based logic, threshold triggers, or adaptive scaling functions.

In one embodiment, the sustainability scoring module 118 is configured to compute environmental impact using one or more parameters, and generate a sustainability impact score (SIS). The sustainability scoring module 118 is configured to compute the environmental impact and a region-specific carbon-optimized routing suggestion for inference workloads across multiple cloud or on-premise deployments using the one or more parameters comprise at least one of energy-per-inference, power-usage-effectiveness (PUE), cloud-region carbon intensity, water-per-kWh, and hardware-type emissions.

In one embodiment, sustainability-related parameters are ingested as machine-readable telemetry, normalized alongside other evidence categories within the unified evidence schema, and computationally weighted as part of composite scoring. The resulting sustainability impact score contributes to actionable system outputs that influence routing, allocation, or enforcement decisions executed by the system 100.

The sustainability scoring module computes measurable indicators of environmental impact associated with AI model execution using the parameters such as energy-per-inference, regional carbon intensity, water consumption characteristics, and power usage effectiveness (PUE) values reported from infrastructure environments. The computed sustainability score is evaluated in combination with clinical safety, performance, and policy thresholds. When the sustainability score or combined ARCSI score falls below a configured threshold, the automated action module 124 initiates system-driven enforcement actions. Such actions include reallocating inference execution to alternate available deployment environments, selecting different compute regions where environmental impact is lower, reducing execution frequency, or blocking execution until compliance is restored. The described computation and automated enforcement steps may be implemented using decision logics, threshold comparisons, and prioritization rules.

In one embodiment, the policy gateway module 120 is configured to enforce data-minimization, jurisdiction rules, consent requirements, and attribute restrictions by applying at least one of masking, truncation, hashing, attribute removal, obfuscation, payload blocking, and routing transformations prior to permitting model invocation in a clinical workflow. The policy gateway module 120 incorporates a machine learning-based classifier trained to label incoming payloads as at least one of compliant, non-compliant, and uncertain, and triggers automatic blocking or manual review for uncertain payloads. The policy gateway module 120 enforces cross-border data residency rules by rewriting payloads to remove jurisdiction-restricted attributes.

The machine learning-based classifier may be implemented using at least one of a supervised or semi-supervised learning model includes, but not limited to, a gradient boosted decision tree model, logistic regression model, neural network model, or transformer-based classifier. Training data for the machine learning-based classifier may comprise, but not limited to, labeled historical compliance records, vendor documentation samples, clinical payload examples, and institutional policy violation incidents, each annotated as compliant, non-compliant, or uncertain. Features extracted from the payload may include attribute presence, metadata structure, jurisdiction markers, data field types, encryption states, risk tags, and contextual workflow indicators. The machine learning-based classifier is periodically retrained using newly ingested governance evidence, thereby ensuring continuous adaptation to regulatory updates and deployment-specific constraints.

In one embodiment, the dynamic monitoring module 122 is configured to perform continuous or periodic monitoring of deployed AI models for detecting at least one of drift, bias spikes, hallucination patterns, latency anomalies, version changes, sustainability anomalies, and regulatory updates, and triggering real-time recalculation of the ARCSI score. The dynamic monitoring module 122 is configured to adjust the ARCSI component weights dynamically such that clinical safety and algorithmic robustness are increased in response to the drift, and security and regulatory weights are elevated in response to vendor breach events. The drift is detected using at least one of population stability index (PSI), Kullback-Leibler (KL) divergence, moving-window performance decay, hallucination-rate spikes, and subgroup-specific accuracy degradation. In one embodiment herein, the processor 106 is configured to automatically modify invocation permissions, data routing paths, compute workload allocation, and execution availability in real-time within a healthcare computing environment, thereby improving safety, latency performance, and infrastructure efficiency.

In one embodiment herein, the processor 106 is configured to automatically modify invocation permissions, data routing paths, compute workload allocation, and execution availability in real-time within a healthcare computing environment. In operation, the system continuously evaluates adaptive risk, compliance, safety, and sustainability states associated with a deployed artificial intelligence model and programmatically enforces technical control actions based on such evaluations. When the adaptive risk, compliance, and sustainability index (ARCSI) falls below a configured threshold, the processor 106 automatically revokes or restricts invocation permissions such that the AI model is blocked, throttled, or constrained from executing within one or more clinical workflows.

Concurrently, the processor 106 dynamically rewrites data routing paths to redirect inference requests toward alternative approved endpoints, safer model instances, or lower-risk compute environments, thereby preventing unauthorized or unsafe execution. The processor 106 further reallocates compute workload distribution across heterogeneous compute resources, including on-premise servers and cloud environments, to optimize latency, maintain system stability, and reduce environmental impact based on sustainability telemetry. The processor 106 additionally modifies execution availability by enabling or disabling specific model instances, model versions, or geographic deployment nodes, such that only compliant and context-appropriate models remain technically executable. These automated enforcement operations are performed without human intervention and are applied at runtime within active healthcare workflows, thereby improving clinical safety by preventing continued use of degraded models, improving latency performance by optimizing routing and compute allocation, and improving infrastructure efficiency by reducing unnecessary compute consumption and environmentally inefficient execution behavior.

In the context of the present disclosure, the term “invocation permissions” refers to technical authorization settings that determine whether an artificial intelligence (AI) model may be executed within a workflow at runtime. Invocation permissions include binary enable/disable states, conditional execution gates, and threshold-controlled execution policies enforced by the system.

The term “data routing paths” refers to computer-implemented pathways that determine where input payloads, intermediate processing data, and model outputs are transmitted within a distributed computing environment, including routing between on-premise servers, hospital networks, cloud regions, inference endpoints, and secure processing nodes.

The term “compute workload allocation” refers to the automated assignment and redistribution of AI inference processing tasks across heterogeneous computing resources, including CPUs, GPUs, edge servers, and cloud compute instances, based on performance, risk, sustainability, or regulatory constraints.

The term “execution availability” refers to whether a particular AI model, model version, or deployment endpoint is technically permitted to process incoming inference requests at a given time, including complete blocking, throttled execution, or restricted execution in certain clinical workflows.

The term “real-time” refers to actions executed automatically by the processor in response to detected events, without human approval, within operational time constraints of active clinical workflows such that clinical decision latency, compliance risk, and safety exposure are minimized.

The term “healthcare computing environment” refers to a networked computing ecosystem including at least one of an electronic health record (EHR) platform, health level seven (HL7) or fast healthcare interoperability resources (FHIR) communication interface, picture archiving and communication system (PACS), clinical application server, on-premise hospital infrastructure, and cloud-hosted inference environment.

In another embodiment, vendor-associated evidence, hospital-provided contextual inputs, inquiry responses, and interaction artifacts directly modify ARCSI component values, weighting logic, confidence levels, and downstream enforcement or monitoring actions, forming a continuous feedback loop. The vendor-associated evidence linked to a specific artificial intelligence model, including regulatory approvals, certifications, audit artifacts, versioned documentation, validation studies, and disclosed adverse events, is ingested as heterogeneous technical evidence, normalized into the unified evidence schema, mapped to regulatory controls, and used to compute and adjust one or more components or weights of the adaptive risk, compliance, and sustainability index (ARCSI).

In some embodiments, the hospital-provided governance inputs, including clinical risk tolerance, deployment phase, and institutional policy constraints, are used as conditioning parameters for adjusting ARCSI component weights and threshold enforcement logic.

In one embodiment, the automated action module 124 is configured to perform at least one of context-aware remediation actions comprises model throttling, clinical-workflow blocking, region-based routing changes, sustainability-optimized allocation, and mandatory vendor revalidation, responsive to the recalculated ARCSI score falling below a configurable threshold. The automated action module 124 dynamically re-allocates inference traffic to minimize carbon per inference while maintaining latency and safety thresholds. The term “region-based routing changes” refers to the automatic reassignment of AI inference execution from one computing region or deployment environment to another available region or deployment environment, based on compliance, safety, performance, or sustainability factors detected by the system 100. The term “sustainability-optimized allocation” refers to the automatic technical selection or reassignment of an execution environment for the AI model in order to reduce environmental impact metrics while maintaining acceptable latency and clinical safety thresholds.

In one embodiment, when predefined confidence thresholds or evidence gaps are detected, the system 100 may trigger structured evaluation interactions, and artifacts generated from such interactions are ingested as additional governance evidence.

In one embodiment, the hospital-vendor compatibility module 126 is configured to compute a compatibility score using features representing vendor compliance posture and hospital infrastructure constraints, and to classify the AI model into a deployment-eligibility category. The hospital-vendor compatibility module 126 is adapted to predict deployment success probability using features comprises EHR type, network latency, cloud strategy, data residency constraints, sustainability goals, and staff workflows. The hospital-vendor compatibility module 126 is adapted to output a market-eligibility category selected from high-likelihood, moderate-likelihood, and low-likelihood deployment suitability.

In one embodiment, the regulatory evidence module 128 is configured to store immutable audit records for each ingestion event, mapping operation, scoring computation, monitoring event, or gateway decision, each audit record comprises timestamp, actor identifier, event type, before/after state hashes, and a previous-record hash forming a tamper-evident chain. The regulatory mapping module 114 assigns the control-coverage states selected from complete, partial, none, and not-applicable, and applies evidence-strength confidence scores. The regulatory evidence module 128 provides time-travel reconstruction of model behavior, policy decisions, and scoring calculations for a selected historical window. The regulatory evidence module 128 automatically assembles one or more regulator-ready bundles comprise at least one of software as a medical device (SaMD) documentation, health insurance portability and accountability act (HIPAA) mappings, general data protection regulation (GDPR) data-minimization evidence, and European Union (EU) Artificial Intelligence (AI) Act risk-management artifacts.

In one embodiment, the ingestion layer 110 further is configured to receive conversational evidence comprising at least one of audio data, video data, text chat data, screen-shared content, or transcripts generated during an AI vendor interaction.

In one embodiment, the system 100 further comprises a conversational evidence ingestion module 130 that is configured to extract conversational statements and classify the extracted statements into one or more fields of the UES.

In some embodiment, the conversational evidence ingestion module 130 is configured to ingest, analyze, and normalize conversational interactions occurring during evaluation of artificial intelligence (AI) vendors or AI models, and to dynamically update evidence records and scoring outputs based on such interactions.

Unlike document-based ingestion processes, the conversational evidence ingestion module 130 enables the system 100 to process live or recorded conversational data, including audio, video, text chat, screen-shared presentations, or combinations thereof, generated during vendor meetings, demonstrations, interviews, or evaluation sessions.

In one embodiment, the conversational evidence ingestion module 130 is configured to ingest conversational data from one or more sources include, but not limited to, audio recordings of calls or meetings, video recordings or live video conference streams, chat transcripts from messaging platforms, in-person conversations captured via room microphones, screen-shared content or presentation materials, and uploaded documents exchanged during the interaction. The conversational data may be ingested in real time or as recorded artifacts following the interaction.

In one embodiment, the conversational evidence ingestion module 130 comprises one or more processing modules that are configured to convert audio or video streams into textual representations using speech-to-text techniques, segment conversational transcripts into utterances, turns, or topical segments, identify statements corresponding to technical claims, disclosures, omissions, uncertainties, or risk indicators associated with an AI model. The extracted conversational content is then classified and mapped into corresponding fields of the Unified Evidence Schema (UES). Extracted conversational evidence may be associated with confidence scores, timestamps, speaker identifiers, and provenance metadata, and linked to the corresponding evaluation session or vendor interaction.

In one embodiment, the scoring module 116 dynamically updates one or more ARCSI components in response to conversational evidence ingested during an ongoing evaluation session. In one embodiment, conversationally extracted evidence is normalized and written into the UES in substantially the same manner as documentary evidence, thereby enabling unified treatment of conversational and non-conversational inputs.

As conversational evidence is added to or modifies the UES, the scoring module 116 dynamically recalculates one or more components of the ARCSI. In certain embodiments, ARCSI scores are updated during an ongoing evaluation session, reflecting newly disclosed information, detected omissions, or emerging risk indicators identified through the conversation.

This dynamic scoring enables real-time or near-real-time adjustment of risk, compliance, safety, and sustainability assessments during vendor interactions.

In one embodiment, the system 100 further comprises an interactive evaluation guidance subsystem configured to generate prompts or questions for a human evaluator based on missing or incomplete evidence detected from conversational analysis.

In some embodiments, the conversational evidence ingestion module 130 further comprises the interactive evaluation guidance subsystem configured to assist a human evaluator during an AI vendor interaction. The interactive guidance subsystem operates as a side-channel interface rendered within a user application, and is dynamically updated based on conversational analysis performed by the conversational evidence ingestion module 130.

As conversational data is ingested and analyzed, the system identifies missing, incomplete, or ambiguous evidence elements relative to the Unified Evidence Schema, regulatory requirements, or organizational evaluation criteria. In response, the guidance subsystem generates suggested prompts, questions, or checklists for presentation to the evaluator.

In an exemplary embodiment, if the system 100 determines that no evidence has been provided regarding model versioning practices, monitoring of performance drift, or subgroup-specific performance metrics, the guidance subsystem may prompt the evaluator to request such information from the vendor.

In one embodiment, conversational responses provided by a vendor are ingested, normalized into the UES, and cause recalculation of ARCSI scores during the same evaluation interaction. The conversational evidence ingestion and guidance subsystem operates in at least one of a fully automated mode or a semi-automated mode configured using predefined evaluation templates or regulatory checklists.

In one embodiment, the conversational evidence ingestion module 130 operates in a closed-loop configuration in which conversational data is ingested and analyzed, missing or incomplete evidence is identified, suggested questions or prompts are generated and presented to the evaluator, vendor responses are ingested and analyzed, and the UES and scoring outputs are updated based on the responses. This closed-loop conversational evaluation enables the system not only to passively ingest evidence, but also to actively guide the evaluation process toward completeness, consistency, and regulatory alignment.

In another embodiment, the conversational evidence ingestion module 130 and the interactive guidance subsystem operate in at least one of a fully automated mode or a semi-automated mode. In the fully automated mode, conversational analysis and guidance generation occur without manual configuration. In the semi-automated mode, administrators configure priority evidence items, regulatory checklists, domain-specific templates, or evaluation policies that influence guidance behavior.

In certain embodiments, the conversational evidence ingestion module 130 supports multi-party conversations, multi-modal interactions, and hybrid environments, includes meetings involving multiple vendors or evaluators, in-person evaluations supplemented by remote participants, and combinations of conversational data and uploaded documents. Conversational evidence ingested through the conversational evidence ingestion module 130 is treated equivalently to other evidence sources for purposes of regulatory mapping, scoring, monitoring, auditability, and remediation.

In one embodiment, conversational ingestion events, extracted evidence, guidance prompts, evaluator actions, and resulting scoring updates are recorded as immutable audit records within the regulatory evidence module 128. Each record includes timestamps, actor identifiers, event types, and cryptographic hashes, thereby enabling reconstruction of evaluation decisions derived from conversational interactions.

In one embodiment herein, the system 100 provides a practical application by integrating directly with external technical systems, including electronic health record (EHR) platforms, HL7/FHIR interfaces, and cloud or on-premise inference infrastructure, such that computed risk and compliance states actively control downstream system behavior. When an adaptive risk, compliance, and sustainability index (ARCSI) falls below a context-specific threshold, the system programmatically modifies data flow, model invocation permissions, and compute routing paths. The system 100 improves safety, reduces computational waste, prevents unauthorized data propagation across jurisdictions, and ensures that only technically compliant artificial-intelligence models are permitted to execute within sensitive workflows. The improvement is therefore rooted in computer technology itself and produces tangible operational effects beyond mere data analysis or abstract evaluation.

Additionally, the system 100 improves computational efficiency and infrastructure utilization by dynamically optimizing inference routing based on sustainability telemetry, including energy-per-inference, regional carbon intensity, and infrastructure efficiency metrics. By reallocating inference workloads to lower-carbon or lower-latency compute regions while maintaining safety thresholds, the system 100 reduces overall resource consumption and network congestion. These operations are performed automatically by the processor 106 in response to detected environmental and operational signals, thereby improving the technical performance of distributed computing systems used for artificial-intelligence deployment.

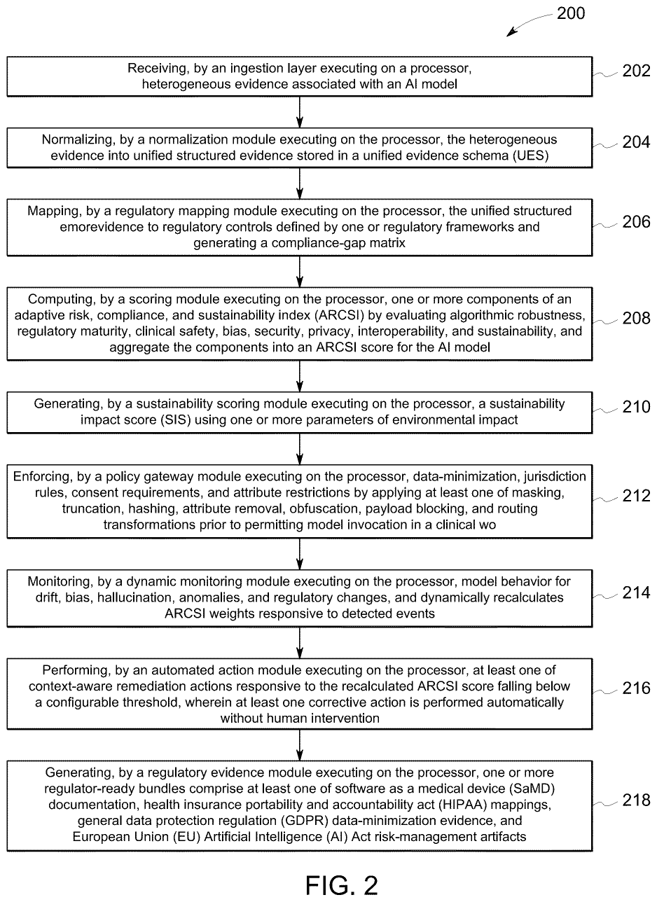

FIG. 2 refers to a flowchart 200 of a computer-implemented method for evaluating and monitoring artificial intelligence (AI) models in healthcare or regulated enterprise workflows. At step 202, the ingestion layer 110 is executed on the processor 106 for receiving the heterogeneous evidence associated with the AI model. At step 204, the normalization module 112 normalizes the heterogeneous evidence into unified structured evidence stored in the UES.

At step 206, the regulatory mapping module 114 maps the unified structured evidence to the regulatory frameworks and generating a compliance-gap matrix. At step 208, the scoring module 116 computes the components of ARCSI by evaluating algorithmic robustness, regulatory maturity, clinical safety, bias, security, privacy, interoperability, and sustainability, and aggregate the components into the ARCSI score for the AI model.

At step 210, the sustainability scoring module 118 generates a sustainability impact score (SIS) using one or more parameters of environmental impact. The sustainability scoring module 118 for AI inference comprises a sustainability metadata vector, a carbon-per-inference calculator, a water-intensity estimator. a routing optimizer, and a sustainability ranking engine configured to generate the SIS for AI models deployed across heterogeneous cloud regions and hardware types.

At step 212, the policy gateway module 120 enforces data-minimization, jurisdiction rules, consent requirements, and attribute restrictions by applying at least one of masking, truncation, hashing, attribute removal, obfuscation, payload blocking, and routing transformations prior to permitting model invocation in the clinical workflow. At step 214, the dynamic monitoring module 122 monitors model behavior for drift, bias, hallucination, anomalies, and regulatory changes, and dynamically recalculates ARCSI weights responsive to detected events.

At step 216, the automated action module 124 performs at least one of context-aware remediation actions comprising model throttling, clinical-workflow blocking, region-based routing changes, sustainability-optimized allocation, and mandatory vendor revalidation, responsive to the recalculated ARCSI score falling below a configurable threshold. At least one corrective action is performed automatically without human intervention.

At step 218, the regulatory evidence module 128 generates the regulator-ready bundles comprise at least one of software as SaMD documentation, HIPAA mappings, GDPR data-minimization evidence, and EU AI Act risk-management artifacts. Hospital contexts are assigned different safety thresholds, such that intensive care unit (ICU) workflows require higher ARCSI scores than outpatient workflows.

In one embodiment, the system 100 for continuous post-deployment monitoring of AI models. In an exemplary embodiment, the system 100 was evaluated for its ability to automatically map heterogeneous vendor-provided evidence to regulatory controls across multiple regulatory frameworks. The automated mapping performed by the regulatory mapping module 114 using the UES is compared against a manual, spreadsheet-based compliance review conducted by a human review committee.

The system 100 identified and mapped a substantially higher proportion of applicable regulatory controls with fewer omissions and inconsistencies than the manual approach. Additionally, the automated mapping process completed regulatory readiness and gap assessments in significantly less time than manual review, thereby reducing operational burden and accelerating procurement and deployment decisions. These results demonstrate that the system 100 provides a technical improvement in regulatory compliance accuracy and processing efficiency through machine-readable normalization and automated control mapping.

In another embodiment, the system 100 is deployed to monitor a clinical AI model operating in a healthcare environment. The dynamic monitoring module 122 continuously evaluated model inputs and outputs using drift detection metrics and subgroup-specific performance analysis.

During operation, the system 100 detected a statistically significant degradation in performance for at least one patient subgroup that was not apparent in periodic manual reviews. Upon detection, the system 100 automatically recalculated ARCSI component weights, increased the influence of the clinical safety and algorithmic robustness components, and triggered automated remediation actions. This early detection and response reduced the duration of exposure to elevated clinical risk and enabled corrective action to be initiated earlier than would be possible with static or periodic review processes.

In an exemplary embodiment, the sustainability scoring module 118 evaluated multiple deployment options for AI inference workloads across heterogeneous cloud regions and hardware configurations. The system 100 computed environmental impact metrics using parameters including energy per inference, regional carbon intensity, water usage per kilowatt-hour, and power usage effectiveness (PUE).

Based on these computations, the system 100 dynamically routed inference workloads to deployment configurations with lower estimated environmental impact while maintaining predefined latency and safety thresholds. As a result, the system 100 achieved a measurable reduction in estimated carbon emissions and energy consumption per inference compared to a baseline deployment that did not account for sustainability metrics. This demonstrates a technical improvement in AI infrastructure operation through sustainability-aware workload allocation.

In an exemplary embodiment, the system 100 was integrated with clinical electronic health record (EHR) and picture archiving and communication system (PACS) workflows. When a deployed AI model experienced operational drift that caused its ARCSI score to fall below a configured threshold for a high-acuity clinical context, the system 100 automatically blocked further model invocation within that workflow.

The automated enforcement occurred without human intervention and prevented continued use of the AI model in a safety-critical context until remediation evidence was provided and validated. This embodiment illustrates the system's ability to provide real-time, context-aware technical enforcement of governance and safety constraints within live clinical environments.

In specified high-risk scenarios, the system 100 produces governance signals and risk indicators that function as decision-support artifacts, which must be affirmatively acknowledged by an authorized human operator before any remediation override or subsequent reauthorization is executed, thereby maintaining required human oversight mandated by applicable policies and regulations.

In one embodiment, the system 100 operates as a governance and decision-support platform, and in higher-risk contexts may require explicit human acknowledgment prior to override or reauthorization.

In an exemplary embodiment, the hospital-vendor compatibility module 126 was evaluated for its ability to predict deployment suitability of AI models across different hospital environments. The hospital-vendor compatibility module 126 analyzed features describing vendor regulatory posture, security controls, sustainability metrics, and hospital-specific infrastructure constraints.

The compatibility scores generated by the system 100 were correlated with observed deployment outcomes, including successful integration, operational stability, and absence of major compliance incidents. The results indicated that the system's compatibility scoring provided meaningful differentiation between high-likelihood and low-likelihood deployment scenarios, enabling more informed and context-sensitive AI adoption decisions.

In an exemplary embodiment, the system 100 automatically generated remediation pathways for regulatory controls that were partially satisfied or unmet. The generated pathways included prioritized corrective actions, required validation artifacts, and target completion timelines.

Compared to manual remediation planning, the automated pathways reduced ambiguity in corrective requirements and improved coordination between vendors and deploying institutions. The structured remediation outputs further enabled faster revalidation and reassessment, supporting continuous compliance throughout the AI model lifecycle.

The foregoing examples demonstrate that the disclosed system 100 provides multiple concrete technical improvements over existing approaches, including automated and accurate regulatory mapping, early detection of clinical and operational risk, sustainability-aware infrastructure optimization, real-time enforcement within clinical workflows, and efficient generation of audit-ready regulatory documentation. These improvements arise from the specific system architecture and interoperation of the disclosed modules, rather than from abstract evaluation or human judgment alone.

The disclosed systems and methods provide multiple technical advancements over conventional artificial intelligence governance, compliance, and monitoring solutions. Unlike existing approaches that rely on static documentation review, manual audits, or post-hoc reporting dashboards, the present disclosure introduces a technically integrated, runtime enforcement architecture that actively controls the operation of deployed AI models in regulated environments.

In one embodiment, the system 100 is configured with an ability to enforce governance, compliance, and safety constraints at runtime by technically intervening in AI model invocation. The system 100 integrates directly with clinical electronic health records (EHRs), picture archiving and communication systems (PACS), and HL7/FHIR endpoints to block, throttle, or reroute AI model invocations when risk thresholds are exceeded. This represents a technical improvement over conventional governance tools that merely generate reports or alerts without affecting system behavior.

In one embodiment, the system 100 is configured with the normalization of heterogeneous, unstructured vendor evidence into a Unified Evidence Schema (UES) that is machine-readable, versioned, and cryptographically linked to source artifacts. This enables automated comparison, validation, and auditability across AI vendors and deployment contexts, overcoming technical limitations of manual document-based compliance processes.

In one embodiment, the system 100 introduces a multi-dimensional Adaptive Risk, Compliance, and Sustainability Index (ARCSI) that dynamically reweights its components in response to detected drift, bias, security incidents, sustainability anomalies, or regulatory updates. This dynamic reweighting enables the system to adapt its risk evaluation logic in real time, which is not achievable with static scoring or periodic assessment systems.

In one embodiment, the system's technical advancement lies in the integration of environmental sustainability metrics directly into AI inference routing and allocation decisions. By computing environmental impact parameters such as energy per inference, regional carbon intensity, water usage, and power usage effectiveness (PUE), the system 100 can automatically route workloads to deployment configurations that minimize environmental impact while maintaining latency and safety constraints. This constitutes a technical improvement in AI infrastructure operation rather than a mere reporting function.

The policy gateway module 120 performs technical payload transformations such as masking, hashing, truncation, attribute removal, and blocking prior to AI model invocation. This enables enforcement of consent, jurisdictional, and data-minimization policies at the data-processing layer itself, rather than relying on downstream access controls or contractual assurances.

The system 100 further provides a technical advancement through the generation of immutable, cryptographically chained audit records for each ingestion, mapping, scoring, monitoring, and enforcement event. This architecture enables time-travel reconstruction of historical compliance states and system decisions, addressing technical shortcomings of conventional audit repositories that lack integrity guarantees and temporal traceability.

Finally, the system 100 enables automated remediation actions, including throttling, blocking, rerouting, and vendor revalidation, to be executed without human intervention when predefined risk thresholds are breached. This autonomous control capability improves system responsiveness and reduces exposure to safety, compliance, and operational risks in high-acuity environments.

Collectively, these technical advancements transform AI governance from a passive, document-centric activity into an active, automated, and technically enforced system that directly improves the operation, safety, and sustainability of deployed artificial intelligence models.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

The claimed invention is:

1. A system for automated governance, compliance evaluation, safety assessment, and sustainability scoring of artificial intelligence (AI) models, comprising:
a computing device having a processor and a memory operatively coupled with the processor, wherein the computing device is in communication with a server via a communication network,
wherein the memory comprises processor-executable instructions which, when executed by the processor, cause the processor to:
receive, by an ingestion layer, heterogeneous evidence associated with an AI model, wherein the heterogeneous evidence comprises at least one of technical documentation, operational logs, model outputs, clinical validation data, regulatory certifications, cybersecurity artifacts, and sustainability telemetry;
convert, by a normalization module, the heterogeneous evidence into unified structured evidence stored in a unified evidence schema (UES), wherein the unified evidence schema comprises a plurality of fields for dataset lineage, performance metrics, clinical safety indicators, regulatory mappings, security posture, operational metadata, sustainability parameters, and provenance hashes;
automatically map, by a regulatory mapping module, the plurality of fields to regulatory controls defined by one or more regulatory frameworks, and to generate a compliance matrix identifying at least one of coverage states, evidence pointers, and remediation gaps;
compute, by a scoring module, one or more components of an adaptive risk, compliance, and sustainability index (ARCSI), and aggregate the components into an ARCSI score for the AI model, wherein the ARCSI score is used by the system to programmatically control model invocation, routing, or blocking within an operational workflow;
compute, by a sustainability scoring module, environmental impact using one or more parameters, and generate a sustainability impact score (SIS);
enforce, by a policy gateway module, data-minimization, jurisdiction rules, consent requirements, and attribute restrictions by applying at least one of masking, truncation, hashing, attribute removal, obfuscation, payload blocking, and routing transformations prior to permitting model invocation in a clinical workflow;
perform, by a dynamic monitoring module, continuous or periodic monitoring of deployed AI models for detecting at least one of drift, bias spikes, hallucination patterns, latency anomalies, version changes, sustainability anomalies, and regulatory updates, and triggering real-time recalculation of the ARCSI score;
perform, by an automated action module, at least one of context-aware remediation actions, which comprises model throttling, clinical-workflow blocking, region-based routing changes, sustainability-optimized allocation, and mandatory vendor revalidation, responsive to the recalculated ARCSI score falling below a configurable threshold;
compute, by a hospital-vendor compatibility module, a compatibility score using features representing vendor compliance posture and hospital infrastructure constraints, and to classify the AI model into a deployment-eligibility category; and
store, by a regulatory evidence module, immutable audit records for each ingestion event, mapping operation, scoring computation, monitoring event, or gateway decision, each audit record comprises at least one of timestamp, actor identifier, event type, before/after state hashes, and a previous-record hash forming a tamper-evident chain,
wherein the processor is configured to automatically modify invocation permissions, data routing paths, compute workload allocation, and execution availability in real-time within a healthcare computing environment, thereby improving safety, latency performance, and infrastructure efficiency, wherein the system automatically generates remediation pathways with prioritized actions, due-date schedules, and required validation artifacts for vendor submission.

2. The system of claim 1, wherein the ingestion layer is configured to receive conversational evidence comprising at least one of audio data, video data, text chat data, screen-shared content, or transcripts generated during an AI vendor interaction.

3. The system of claim 1, wherein the one or more regulatory frameworks comprises at least one of health insurance portability and accountability act (HIPAA), food and drug administration (FDA) software as a medical device (SaMD) guidance, office of the national coordinator for health information technology health data, technology, and interoperability rule (ONC HTI-1), national institute of standards and technology artificial intelligence risk management framework (NIST AI RMF), ISO/IEC 42001 artificial intelligence management system standard, ISO/IEC 27001 and ISO/IEC 27701 information security and privacy standards, general data protection regulation (GDPR), and European union artificial intelligence act (EU AI Act).

4. The system of claim 1, wherein the scoring module comprises a plurality of scoring modules, including at least one of an algorithmic robustness module, a regulatory maturity module, a clinical safety and bias module, a security and privacy module, and an infrastructure and sustainability module.

5. The system of claim 1, wherein the sustainability scoring module is configured to compute the environmental impact and a region-specific carbon-optimized routing suggestion for inference workloads across multiple cloud or on-premise deployments using the one or more parameters comprise at least one of energy-per-inference, power-usage-effectiveness (PUE), cloud-region carbon intensity, water-per-kWh, and hardware-type emissions.

6. The system of claim 1, wherein the policy gateway module incorporates a machine learning-based classifier trained to label incoming payloads as at least one of compliant, non-compliant, and uncertain, and triggers automatic blocking or manual review for uncertain payloads.

7. The system of claim 1, wherein the policy gateway module enforces cross-border data residency rules by rewriting payloads to remove jurisdiction-restricted attributes.

8. The system of claim 1, wherein the dynamic monitoring module is configured to adjust the ARCSI component weights dynamically such that clinical safety and algorithmic robustness are increased in response to the drift, and security and regulatory weights are elevated in response to vendor breach events.

9. The system of claim 1, wherein the drift is detected using at least one of population stability index (PSI), Kullback-Leibler (KL) divergence, moving-window performance decay, hallucination-rate spikes, and subgroup-specific accuracy degradation.

10. The system of claim 1, wherein the automated action module dynamically re-allocates inference traffic to minimize carbon per inference while maintaining latency and safety thresholds.

11. The system of claim 1, wherein the hospital-vendor compatibility module is adapted to predict deployment success probability using features comprises EHR type, network latency, cloud strategy, data residency constraints, sustainability goals, and staff workflows, wherein the hospital-vendor compatibility module is adapted to output a market-eligibility category selected from high-likelihood, moderate-likelihood, and low-likelihood deployment suitability.

12. The system of claim 1, wherein the regulatory mapping module assigns the control-coverage states selected from complete, partial, none, and not-applicable, and applies evidence-strength confidence scores.

13. The system of claim 1, wherein the regulatory evidence module provides time-travel reconstruction of model behavior, policy decisions, and scoring calculations for a selected historical window.

14. The system of claim 1, wherein the regulatory evidence module automatically assembles one or more regulator-ready bundles comprise at least one of software as a medical device (SaMD) documentation, health insurance portability and accountability act (HIPAA) mappings, general data protection regulation (GDPR) data-minimization evidence, and European Union (EU) Artificial Intelligence (AI) Act risk-management artifacts.

15. The system of claim 1, wherein the system integrates with at least one of clinical electronic health records (EHRs), picture archiving and communication system (PACS), and health level seven (HL7) endpoint or fast healthcare interoperability resources (FHIR) endpoint to block real-time model invocation when ARCSI falls below a context-specific threshold.

16. The system of claim 1, wherein the system operates continuously post-deployment without retraining the AI model.

17. The system of claim 1, wherein the system comprises a conversational evidence ingestion module configured to extract conversational statements and classify the extracted statements into one or more fields of the UES.

18. The system of claim 1, wherein the system comprises an interactive evaluation guidance subsystem configured to generate prompts or questions for a human evaluator based on missing or incomplete evidence detected from conversational analysis.

19. The system of claim 1, wherein the heterogeneous evidence comprises one or more hospital-provided governance inputs, which include clinical use-case classification, deployment phase indicators, and institutional risk thresholds, and wherein the scoring module conditions ARCSI component weights based on the one or more hospital-provided governance inputs.

20. A computer-implemented method for evaluating and monitoring artificial intelligence (AI) models in healthcare or regulated enterprise workflows, the method comprising:
receiving, by an ingestion layer executing on a processor, heterogeneous evidence associated with an AI model;
normalizing, by a normalization module executing on the processor, the heterogeneous evidence into unified structured evidence stored in a unified evidence schema (UES);
mapping, by a regulatory mapping module executing on the processor, the unified structured evidence to regulatory controls defined by one or more regulatory frameworks and generating a compliance-gap matrix;
computing, by a scoring module executing on the processor, one or more components of an adaptive risk, compliance, and sustainability index (ARCSI) by evaluating algorithmic robustness, regulatory maturity, clinical safety, bias, security, privacy, interoperability, and sustainability, and aggregate the components into an ARCSI score for the AI model, wherein automatically modifying system behavior based on the ARCSI score by blocking, throttling, or rerouting artificial intelligence model execution within the workflow;
generating, by a sustainability scoring module executing on the processor, a sustainability impact score (SIS) using one or more parameters of environmental impact;
enforcing, by a policy gateway module executing on the processor, data-minimization, jurisdiction rules, consent requirements, and attribute restrictions by applying at least one of masking, truncation, hashing, attribute removal, obfuscation, payload blocking, and routing transformations prior to permitting model invocation in a clinical workflow;
monitoring, by a dynamic monitoring module executing on the processor, model behavior for drift, bias, hallucination, anomalies, and regulatory changes, and dynamically recalculates ARCSI weights responsive to detected events;
performing, by an automated action module executing on the processor, at least one of context-aware remediation actions responsive to the recalculated ARCSI score falling below a configurable threshold, wherein at least one corrective action is performed automatically without human intervention; and
generating, by a regulatory evidence module executing on the processor, one or more regulator-ready bundles comprise at least one of software as a medical device (SaMD) documentation, health insurance portability and accountability act (HIPAA) mappings, general data protection regulation (GDPR) data-minimization evidence, and European Union (EU) Artificial Intelligence (AI) Act risk-management artifacts.
